(19) United States
(12) Patent Application Publication
(10) Pub. No.: US 2025/0347510 A1
(43) Pub. Date: Nov. 13, 2025

(54) INTERFEROMETRIC MEASUREMENT APPARATUS

(71) Applicant: HAMAMATSU PHOTONICS K.K., Hamamatsu-shi (JP)

(72) Inventors: Hisanari TAKAHASHI, Hamamatsu-shi (JP); Hiroshi SATOZONO, Hamamatsu-shi (JP); Naoya KAWAI, Hamamatsu-shi (JP)

(73) Assignee: HAMAMATSU PHOTONICS K.K., Hamamatsu-shi (JP)

(21) Appl. No.: 19/192,612

(22) Filed: Apr. 29, 2025

(30) Foreign Application Priority Data
May 7, 2024 (JP) 2024-075160

(51) Int. Cl. G01B 9/02; G02B 27/14

(52) U.S. Cl. CPC G01B 9/02083; G02B 27/142

(57) ABSTRACT

An interferometric measurement device includes an interferometric optical system that includes a beam splitter that splits the measurement light into a first and second split lights, a first optical path that reflects the first split light and re-enters it into the beam splitter, and a second optical path in which the second split light is folded back by a mirror member via a rotating mirror, wherein the interferometric optical system combines the first and second split lights re-entered into the beam splitter, a photomultiplier tube that detects the interference light of the first and second split lights, and an analysis unit that acquires a signal waveform that associates a measurement value of the detected interference light with an optical path length difference. The analysis unit monitors the beam position displaced according to the rotation of the rotating mirror and acquires the signal waveform based on the beam position.

### TECHNICAL FIELD

The present disclosure relates to an interferometric measurement apparatus.

### CROSS-REFERENCE TO RELATED APPLICATIONS

This application claims the benefit of priority from Japanese Patent Application No. 2024-075160 filed on May 7, 2024, the entire contents of which are incorporated herein by reference.

### BACKGROUND

Terahertz waves are light in the intermediate region between light waves and radio waves (band around a frequency of 1 THz) and have unique absorption spectra for analytes such as pharmaceuticals that are not seen in other wavelength bands. Therefore, their use in the identification of analytes is expected. Various techniques using terahertz waves for analysis are known.

Terahertz Time Domain Spectroscopy (THz-TDS) measures the temporal waveform of terahertz waves transmitted, reflected, or totally reflected by an analyte, and analyzes the analyte by Fourier transforming the temporal waveform of the electric field amplitude of the terahertz waves obtained by this measurement (Non-Patent Document 1: Jens Neu, et al, “Tutorial: An introduction to terahertz time domain spectroscopy (THz-TDS),” J. Appl. Phys. 124, 231101 (2018)). Hereinafter, this will be referred to as “Related Art 1”. In Related Art 1, a lock-in amplifier is used when measuring the temporal waveform of terahertz waves.

By using a terahertz wave source with a variable output wavelength and detecting the terahertz waves transmitted, reflected, or totally reflected by the analyte, the analyte can be analyzed (Non-Patent Document 2: K. Murate, et al, “Perspective: Terahertz wave parametric generator and its applications,” J. Appl. Phys. 124, 160901 (2018)). Hereinafter, this will be referred to as “Related Art 2”. In Related Art 2, a thermal detector is used for detecting terahertz waves.

Furthermore, Fourier spectroscopy using interferometric measurement with terahertz waves, similar to Fourier Transform Infrared Spectroscopy (FTIR), can also be used to analyze analytes (Non-Patent Document 3: Masashi Yamaguchi, et al, “Terahertz wave generation in nitrogen gas using shaped optical pulses,” J. Opt. Soc. Am. B, Vol. 26, No. 9 (2009)). Hereinafter, this will be referred to as “Related Art 3”. In Related Art 3, a thermal detector is used for detecting the interference of terahertz waves.

### SUMMARY

In Related Art 1, a long integration time using a lock-in amplifier is required when measuring the temporal waveform of terahertz waves. In Related Arts 2 and 3, thermal detectors with slow response are used, resulting in long measurement times. Conventional analysis techniques using terahertz waves, including Related Arts 1 to 3, require a long time for measurement. The above issues also apply when using measurement light in the mid-infrared region close to the terahertz region.

Therefore, one aspect of the present disclosure aims to provide an interferometric measurement apparatus capable of performing interferometric measurement using measurement light in the mid-infrared region or terahertz region quickly and suitably.

The present disclosure includes the following interferometric measurement apparatuses [1] to [11].

[1] An interferometric measurement apparatus including: a light source that outputs measurement light included in a wavelength range of the mid-infrared region or terahertz region; an interferometric optical system that includes: a beam splitter that splits the measurement light output from the light source into a first split light and a second split light; a first optical path on which the first split light from the beam splitter is reflected by a first mirror and re-enters the beam splitter; and a second optical path on which the second split light from the beam splitter travels to a third mirror via a second mirror and an optical component in this order and returns to the beam splitter via the optical component and the second mirror after being reflected by the third mirror, and wherein the interferometric optical system is configured to combine the first split light and the second split light re-entered into the beam splitter; a first detector sensitive to the wavelength of the measurement light and configured to detect interference light of the measurement light generated by the combination of the first split light and the second split light at the beam splitter; an analysis unit configured to acquire a signal waveform that associates a measurement value corresponding to an intensity of the interference light detected by the first detector with an optical path length difference between the first optical path and the second optical path, and analyze an analyze-target object disposed on an optical path of the measurement light based on the acquired signal waveform, wherein the second mirror is configured to be rotationally driven to change an optical path length of the second optical path, wherein the optical component is configured to condense or collimate the second split light from the second mirror, and wherein the analysis unit is configured to monitor a beam position corresponding to a light incident position on the third mirror displaced according to rotation of the second mirror, and acquire the signal waveform based on the beam position.

According to the interferometric measurement apparatus of [1], by rotationally driving the second mirror, the optical path length difference (i.e., the time difference corresponding to the optical path length difference) between the first optical path and the second optical path can be changed quickly compared to configuring the second mirror as a mirror that can be moved parallel to the mirror surface and therefore the interferometric measurement can be performed quickly. Here, to appropriately perform the interferometric measurement, it is necessary to accurately grasp the optical path length difference (time difference) at each measurement point, which requires obtaining information on the rotation angle of the second mirror at each point. However, when the second mirror is rotationally driven at high speed, it is difficult to directly grasp the rotation angle of the second mirror at each point. Therefore, in the interferometric measurement apparatus of [1], instead of monitoring the rotation angle of the second mirror itself, the beam position on the third mirror displaced according to the rotation of the second mirror is monitored to indirectly grasp the rotation angle of the second mirror, and obtain a signal waveform that associates the measurement value (corresponding to the intensity of the interference light) of the first detector with the optical path length difference corresponding to the rotation angle. This allows the analysis based on the signal waveform to be performed quickly and easily by quickly changing the optical path length difference between the first optical path and the second optical path by rotationally driving the second mirror. Therefore, according to the interferometric measurement apparatus of [1], interferometric measurement using measurement light in the mid-infrared region or terahertz region can be performed quickly and suitably.

[2] The interferometric measurement apparatus according to [1], wherein the light source further outputs reference light having a wavelength different from that of the measurement light and incident coaxially with the measurement light into the beam splitter, and wherein the analysis unit is configured to monitor the beam position corresponding to a light incident position of the reference light on the third mirror displaced according to rotation of the second mirror.

According to the configuration of [2], by using reference light different from the measurement light for monitoring the beam position, it is possible to prevent a part of the measurement light from being used for monitoring the beam position. This prevents a reduction in the amount of interference light of the measurement light detected by the first detector, allowing interferometric measurement using the measurement light to be performed more suitably.

[3] The interferometric measurement apparatus according to [2], further comprising a second detector configured to detect the reference light transmitted through the third mirror, wherein the third mirror is configured to reflect the measurement light and transmit the reference light, and wherein the analysis unit is configured to monitor a light incident position of the reference light on a detection surface of the second detector as the beam position.

According to the configuration of [3], only the measurement light is reflected by the third mirror, and the reference light used for monitoring the beam position does not return to the beam splitter side. This prevents the reference light from returning to the light source side and unexpectedly affecting the interferometric measurement, thereby improving the stability of the interferometric measurement.

[4] The interferometric measurement apparatus according to [3], wherein the third mirror and the detection surface of the second detector are arranged so that an air layer is not formed between them.

According to the configuration of [4], since the detection surface of the second detector is disposed close proximity to the rear of the third mirror (the side opposite to the mirror surface), the displacement of the beam position of the reference light according to the rotation of the second mirror can be accurately detected by the second detector. As a result, the accuracy of the interferometric measurement can be improved.

[5] The interferometric measurement apparatus according to [3] or [4], wherein the third mirror includes an ITO film.

According to the configuration of [5], a third mirror that reflects measurement light included in the wavelength range of the mid-infrared region or terahertz region and transmits reference light not included in the wavelength range can be suitably realized.

[6] The interferometric measurement apparatus according to any one of [2] to [5], wherein the light source includes an output unit that outputs pulsed light and an optical crystal that generates the measurement light in response to irradiation of the pulsed light, and wherein the light source is configured to output the pulsed light transmitted through the optical crystal as the reference light.

According to the configuration of [6], since only the device that generates the pulsed light (reference light) as the seed light needs to be prepared as the light source device, the overall configuration of the light source can be made compact. Furthermore, by using pulsed light with a relatively high wavelength conversion efficiency in the optical crystal, the measurement light can be generated efficiently.

[7] The interferometric measurement apparatus according to any one of [2] to [6], wherein the reference light is visible light.

According to the configuration of [7], by visually recognizing the position of the reference light, it is possible to easily perform assembly work of the interferometric optical system (e.g., arrangement of optical components and the third mirror) and monitoring of the beam position on the third mirror. Furthermore, the second detector for detecting the reference light can be constituted by a relatively inexpensive light detector.

[8] The interferometric measurement apparatus according to any one of [2] to [6], wherein the reference light is near-infrared light.

There are many optical crystals that generate terahertz waves in response to irradiation with near-infrared light. Therefore, according to the configuration of [8], the measurement light, which is a terahertz wave, can be generated efficiently, and the degree of freedom in selecting the material of the optical crystal can be improved.

[9] The interferometric measurement apparatus according to any one of [1] to [8], wherein the analysis unit is configured to: perform a first process of measuring the beam position for each of a plurality of rotation angles of the second mirror and calculating a first relational expression indicating a relationship between the rotation angle of the second mirror and the beam position; perform a second process of measuring a time difference corresponding to the optical path length difference at a time when a peak of the intensity of the interference light of the measurement light is obtained for each of the plurality of rotation angles of the second mirror and calculating a second relational expression indicating a relationship between the rotation angle of the second mirror and the time difference; perform a third process of calculating a third relational expression indicating a relationship between the beam position and the time difference based on the first relational expression and the second relational expression; and perform a fourth process of acquiring the signal waveform based on the measurement value corresponding to the intensity of the interference light detected by the first detector, the beam position, and the third relational expression.

According to the configuration of [9], by performing simple calculation processes step by step, the signal waveform for analyzing the analyze-target object can be obtained reliably and easily.

[10] The interferometric measurement apparatus according to [9], wherein the first mirror is configured to be driven to change an optical path length of the first optical path, and wherein the analysis unit is configured to measure the time difference corresponding to the angle for a plurality of angles by driving the first mirror while fixing the rotation angle of the second mirror to a certain angle in the second process.

According to the configuration of [10], by driving the first mirror forming the first optical path, the process of measuring the time difference corresponding to each of the plurality of rotation angles in the second process can be performed efficiently.

[11] The interferometric measurement apparatus according to any one of [1] to [10], wherein the first detector is a photomultiplier tube, and wherein the analysis unit is configured to convert the intensity of the interference light detected by the first detector into an electric field amplitude value based on a relationship between the electric field amplitude value of the light incident on the first detector and the electrical signal value output from the first detector, acquire the signal waveform that associates the electric field amplitude value with the time difference corresponding to the optical path length difference, and analyze the analyze-target object by performing Fourier transform on the signal waveform.

According to the configuration of [11], Fourier spectroscopy using interferometric measurement with the measurement light can be performed quickly and accurately.

According to one aspect of the present disclosure, it is possible to provide an interferometric measurement apparatus capable of performing interferometric measurement using measurement light in the mid-infrared region or terahertz region quickly and suitably.

### BRIEF DESCRIPTION OF THE DRAWINGS

FIG. 1 is a diagram showing a configuration example of an interferometric measurement apparatus according to one embodiment.

FIG. 2 is a diagram showing a configuration example of a photomultiplier tube 30.

FIG. 3A is a graph showing the input-output characteristics of the photomultiplier tube 30. FIG. 3B is a graph showing the time dependence of the voltage signal V output from the photomultiplier tube 30.

FIGS. 4A and 4B are diagrams schematically showing examples of beam position displacement when the rotation angle of the rotating mirror changes from angle θ1 to angle θ2.

FIG. 5 is a diagram showing an example of a graph indicating the relationship between the rotation angle and the beam position obtained by the first process of the analysis unit 50.

FIG. 6 is a flowchart showing an example of the second process of the analysis unit 50.

FIG. 7 is a diagram showing an example of multiple interference waveforms obtained in the second process of the analysis unit 50.

FIG. 8 is a diagram showing an example of a graph indicating the relationship between the rotation angle and the time difference obtained in the second process of the analysis unit 50.

FIG. 9 is a diagram showing an example of a graph indicating the relationship between the beam position and the time difference obtained in the third process of the analysis unit 50.

FIG. 10 is a diagram schematically showing an example of the fourth process of the analysis unit 50.

FIG. 11 is a graph showing the dependence of Vp-p on the time difference Δt.

FIG. 12A is a graph showing the dependence of the electric field amplitude value E of the interference light on the time difference Δt. FIG. 12B is a diagram showing the amplitude spectrum and phase spectrum of the electric field amplitude value E of the interference light.

FIG. 13 is a graph showing the relationship (FN equation) between the output value V of the photomultiplier tube 30 and the electric field amplitude value E of the incident terahertz wave obtained by fitting processing.

FIG. 14 is a table showing an example of the correspondence between the electric field amplitude value E of the incident terahertz wave and the output value V of the photomultiplier tube 30 calculated using the FN equation.

FIG. 15A is a graph showing the dependence of the electric field amplitude value E of the interference light on the time difference Δt. FIG. 15B is a graph showing the phase spectrum of the electric field amplitude value E of the interference light.

FIG. 16A is a graph showing the amplitude spectrum of the electric field amplitude value E of the interference light. FIG. 16B is a graph showing the spectrum of the absorption coefficient α(ω). FIG. 16C is a graph showing the spectrum of the refractive index n(ω).

FIGS. 17A and 17B are diagrams showing modified examples of the interferometric measurement apparatus.

### DETAILED DESCRIPTION

Hereinafter, an embodiment of the present disclosure will be described in detail with reference to the drawings. In the following description, the same or corresponding elements are denoted by the same reference numerals, and redundant descriptions are omitted.

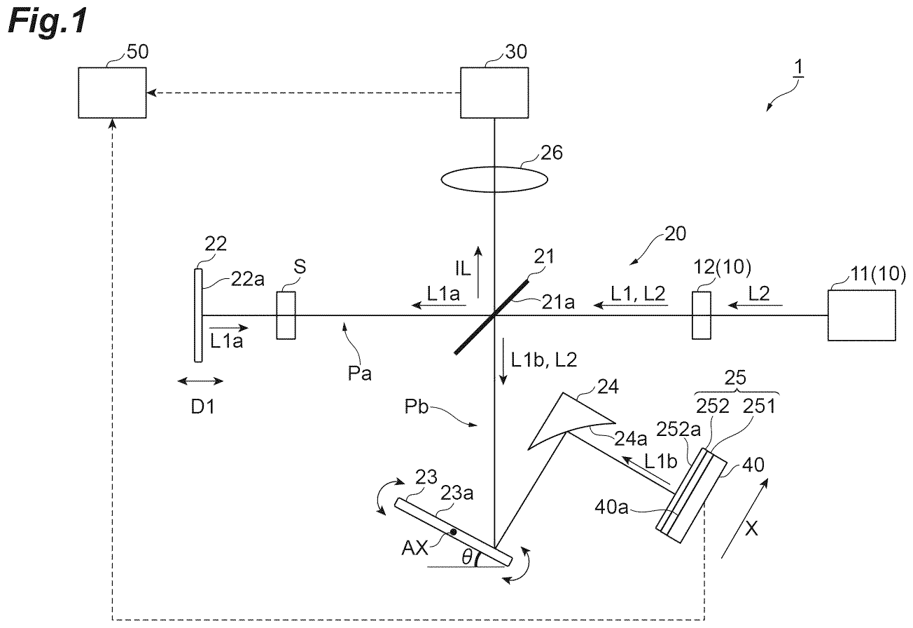

As shown in FIG. 1, an interferometric measurement apparatus 1 according to one embodiment includes a light source 10, an interferometric optical system 20, a photomultiplier tube 30 (first detector), a position sensor 40 (second detector), and an analysis unit 50.

The light source 10 outputs measurement light L1 included in a wavelength range of the mid-infrared region or terahertz region. The light source 10 is further configured to output reference light L2 having a wavelength different from that of the measurement light L1. The measurement light L1 is, for example, a terahertz wave included in the terahertz region (e.g., wavelength range of 30 μm to 3 mm). The reference light L2 is, for example, light included in a wavelength range of 200 nm to 2.5 μm. In this embodiment, the measurement light L1 and the reference light L2 are pulsed light. However, the measurement light L1 and the reference light L2 may be continuous light.

The light source 10 includes an output unit 11 that outputs pulsed light and an optical crystal 12 that generates the measurement light L1 in response to irradiation of the pulsed light. The light source 10 also outputs the pulsed light transmitted through the optical crystal 12 as the reference light L2. That is, the light source 10 outputs the measurement light L1 and the reference light L2 coaxially toward an incident surface 21a of a beam splitter 21 described later by irradiating the optical crystal 12 with the pulsed light, which is the reference light L2.

The output unit 11 is, for example, an ultrashort pulsed laser. As an example, the output unit 11 is constituted by a femtosecond laser with a pulse width shorter than 100 fs. Examples of the output unit 11 include a titanium-sapphire laser, an Er fiber laser, and an Yb fiber laser.

The optical crystal 12 is formed of a material capable of generating terahertz waves (measurement light L1). Examples of the optical crystal 12 include ZnTe crystal (excited wavelength 800 nm), GaSe crystal (excited wavelength 800 nm), DAST crystal (excited wavelength 1.5 μm), GaAs photoconductive antenna (excited wavelength 800 nm), and InGaAs photoconductive antenna (excited wavelength 1.5 μm).

In this embodiment, the reference light L2 output from the output unit 11 is near-infrared light (light in the wavelength range of 780 nm to 2.5 μm). As an example, the reference light L2 is pulsed light with a wavelength of 800 nm. The optical crystal 12 is a ZnTe crystal.

The interferometric optical system 20 includes a beam splitter 21, a linear stage 22 (first mirror), a rotating mirror 23 (second mirror), a parabolic mirror 24 (optical component), a mirror member 25 (third mirror), and a lens 26.

The beam splitter 21 is a silicon plate formed of silicon with a resistivity of 100 Ω·cm, for example. The incident surface 21a of the beam splitter 21, where the measurement light L1 and the reference light L2 from the light source 10 are incident, may be coated to reflect most of the reference light L2. In this case, the beam splitter 21 can split the measurement light L1 into an optical path Pa and an optical path Pb while guiding most of the reference light L2 to the optical path Pb. Examples of coating materials include dielectric multilayer films such as TiO2 and SiO2. However, if the beam splitter 21 is formed of silicon with a resistivity of 100 Ω·cm or more, the reflectivity of the reference light L2 will be almost 100%, so coating may not be necessary.

The beam splitter 21 splits the measurement light L1 into a split light L1a (first split light) and a split light L1b (second split light). This forms an optical path Pa (first optical path) through which the split light L1a passes and an optical path Pb (second optical path) through which the split light L1b passes in the interferometric optical system 20. In this embodiment, the optical path Pa is an optical path through which the split light L1a transmitted through the beam splitter 21 passes, and the optical path Pb is an optical path through which the split light L1b and the reference light L2 reflected by the incident surface 21a of the beam splitter 21 pass.

The optical path Pa is an optical path in which the split light L1a from the beam splitter 21 is reflected by the mirror surface 22a of the linear stage 22 and re-enters the beam splitter 21 (the surface opposite to the incident surface 21a). That is, the optical path Pa is constituted by an outward path from the beam splitter 21 to the linear stage 22 and a return path from the linear stage 22 to the beam splitter 21.

The optical path Pb is an optical path in which the split light L1b and the reference light L2 from the beam splitter 21 are reflected by the rotating mirror 23 and re-enter the beam splitter 21 (incident surface 21a). In this embodiment, the optical path Pb is constituted by an outward path in which the split light L1b and the reference light L2 from the beam splitter 21 travel to the mirror member 25 via the rotating mirror 23 and the parabolic mirror 24 in this order, and a return path in which the split light L1b is reflected by the mirror member 25 and returns to the beam splitter 21 via the parabolic mirror 24 and the rotating mirror 23 in this order.

The linear stage 22 is disposed downstream of the beam splitter 21 in the optical path Pa. The surface of the linear stage 22 on which the split light L1a is incident is constituted by a mirror surface 22a that reflects the split light L1a. In this embodiment, the linear stage 22 is configured to be movable in the direction DI along the optical path Pa (the direction perpendicular to the mirror surface 22a). The position of the linear stage 22 in the direction DI is set such that the optical path length difference Δd between the split light L1a (optical path Pa) and the split light L1b (optical path Pb) is near zero, for example. The split light L1a incident on the mirror surface 22a of the linear stage 22 is reflected by the mirror surface 22a and returned to the beam splitter 21. In this embodiment, the analyze-target object S is disposed on the optical path Pa. The analyze-target object S may be, for example, lactose, sucrose, or other sugars.

The rotating mirror 23 is disposed downstream of the beam splitter 21 in the optical path Pb. The rotating mirror 23 is configured to be rotatable (oscillatable) within a predetermined angle range around an axis AX extending in a direction perpendicular to the optical path Pb (in the example of FIG. 1, a direction perpendicular to the paper surface). The axis AX of the rotating mirror 23 is located at a position offset from the optical path Pb. The rotating mirror 23 is configured to be rotatable around the axis AX at high speed so as to change the distance between the beam splitter 21 and the mirror surface 23a of the rotating mirror 23 in the optical path Pb.

As an example, the rotating mirror 23 is configured to rotate within a predetermined angle θmax in the direction in which the optical path length of the optical path Pb increases (i.e., the direction in which the distance from the beam splitter 21 to the mirror surface 23a increases (clockwise direction in FIG. 1)) when the rotation angle at which the optical path length difference Δd between the optical path Pa and the optical path Pb becomes zero as angle θr. That is, the rotating mirror 23 is configured to be rotatable at a predetermined frequency such that the angle of the rotating mirror 23 periodically changes between the angle θr when the optical path length difference Δd is zero and the angle θr+θmax when the optical path length difference Δd (“the optical path length of the optical path Pb−the optical path length of the optical path Pa” in this embodiment) is maximum dmax.

The width of the periodic change in the optical path length difference Δd due to the rotational driving of the rotating mirror 23 (dmax in this embodiment) is set to 3 mm or more, for example. For example, the position of the rotating mirror 23 (i.e., the position of the axis AX) is adjusted such that the optical path length difference Δd changes by about 1 μm when the angle of the rotating mirror 23 changes by 0.0025°. In this case, by rotating the rotating mirror 23 with θmax=25°, the optical path length difference Δd can be periodically changed between the state where the optical path length difference Δd is zero (i.e., when the angle of the rotating mirror 23 is θr) and the state where the optical path length difference Δd is dmax (10 μm) (i.e., when the angle of the rotating mirror 23 is θr+θmax).

The mirror surface 23a of the rotating mirror 23 is configured to reflect the split light L1b (terahertz wave in this embodiment) and the reference light L2 (near-infrared light in this embodiment). The mirror surface 23a may be formed of a metal such as Al, Ag, or Au.

The parabolic mirror 24 is disposed downstream of the rotating mirror 23 in the optical path Pb. The parabolic mirror 24 is an optical component that collimates the split light L1b and the reference light L2 from the rotating mirror 23 and guides them to the mirror member 25. That is, the parabolic mirror 24 collimates the split light L1b and the reference light L2 with a parabolic mirror surface 24a and reflects them toward the mirror member 25.

The mirror member 25 is disposed downstream of the parabolic mirror 24 in the optical path Pb. The mirror member 25 is configured to reflect the split light L1b (measurement light L1) and transmit the reference light L2. As an example, the mirror member 25 is an ITO (Indium Tin Oxide) coated glass. That is, the mirror member 25 includes a glass substrate 251 and an ITO film 252 coated (formed) on the surface of the glass substrate 251 (the surface facing the parabolic mirror 24).

The ITO film 252 has a high reflectivity for terahertz waves (about 99%) and a high transmittance for near-infrared light (95% or more). Therefore, the split light L1b that reaches the mirror member 25 is reflected by the surface 252a of the ITO film 252 (the surface opposite to the glass substrate 251). The mirror member 25 is arranged such that its surface (surface 252a) is perpendicular to the optical axis of the split light L1b and the reference light L2 reflected by the parabolic mirror 24. As a result, the split light L1b that reaches the surface 252a of the ITO film 252 from the mirror surface 24a of the parabolic mirror 24 re-enters the position where it was first reflected by the mirror surface 24a in the reverse direction along the same path. Subsequently, the split light L1b is reflected by the mirror surface 24a and re-enters the mirror surface 23a of the rotating mirror 23, and is reflected by the mirror surface 23a to re-enter the incident surface 21a of the beam splitter 21. In contrast, the reference light L2 that reaches the mirror member 25 passes through the ITO film 252 and the glass substrate 251 and enters the detection surface 40a of the position sensor 40 described later.

The beam splitter 21 combines the split light L1a re-entering the beam splitter 21 (the surface opposite to the incident surface 21a) via the optical path Pa and the split light L1b re-entering the beam splitter 21 (incident surface 21a) via the optical path Pb. In this embodiment, the interference light IL generated by combining the component of the split light L1a re-entering the beam splitter 21 and reflected by the beam splitter 21 (the surface opposite to the incident surface 21a) and the component of the split light L1b re-entering the beam splitter 21 and transmitted through the beam splitter 21 (incident surface 21a) is emitted from the beam splitter 21 toward the photomultiplier tube 30.

The lens 26 is disposed downstream of the beam splitter 21 in the optical path of the interference light IL (i.e., between the beam splitter 21 and the photomultiplier tube 30). The lens 26 is a lens that condenses the interference light IL to enhance the efficiency of the interference light IL incident on the photomultiplier tube 30. The lens 26 is, for example, a condensing lens for the terahertz wave band with a focal length of 50 mm (e.g., Tsurupica (registered trademark) or the like).

The photomultiplier tube 30 is disposed downstream of the lens 26. The photomultiplier tube 30 is sensitive to the wavelength of the measurement light L1 (terahertz region in this embodiment) and detects the interference light IL of the measurement light L1 generated by the combination of the split light L1a and the split light L1b at the beam splitter 21. That is, the photomultiplier tube 30 outputs an electrical signal value corresponding to the incident light intensity of the interference light IL.

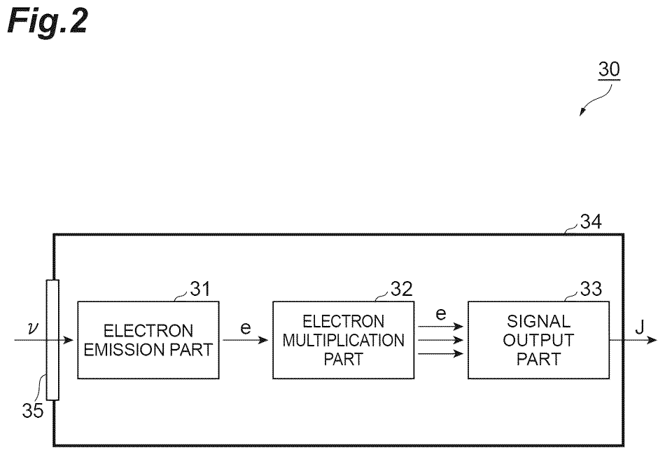

FIG. 2 is a block diagram showing the configuration of the photomultiplier tube 30. The photomultiplier tube 30 includes an electron emission part 31, an electron multiplication part 32, and a signal output part 33, all of which are disposed inside a housing 34 maintained in a vacuum. The housing 34 is provided with a window part 35.

The electron emission part 31 emits electrons e when light v transmitted through the window part 35 is incident. The electron emission part 31 is a photoelectric conversion part designed to be sensitive to the light band including the measurement light L1 to be detected. The electron emission part 31 has a configuration in which a metamaterial structure (metasurface) is formed on the main surface of a substrate, and electrons e can be emitted by the incidence of light on the metasurface.

The electron multiplication part 32 multiplies the electrons e emitted from the electron emission part 31. The electron multiplication part 32 includes multiple stages of dynodes or a microchannel plate. The electron multiplication factor in the electron multiplication part 32 depends on the voltage applied to the multiple stages of dynodes or the microchannel plate. The signal output part 33 collects the electrons e multiplied by the electron multiplication part 32 and outputs them as a current signal J. The analysis unit 50, described later, may input the current signal J output from the signal output part 33 or the voltage signal after the current signal J is converted by an IV conversion circuit. In this embodiment, the voltage signal is input to the analysis unit 50 as the electrical signal value output by the photomultiplier tube 30.

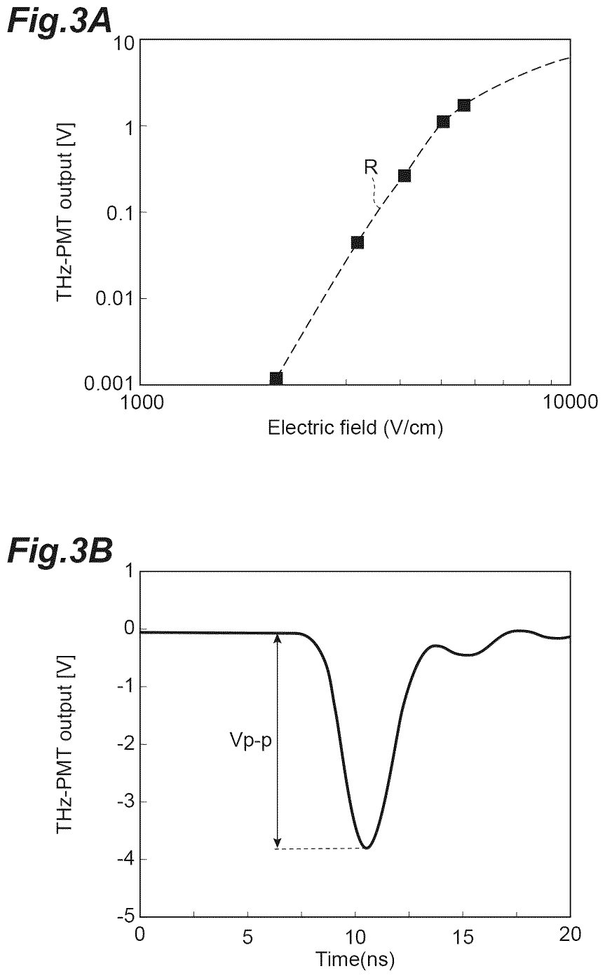

FIG. 3A is a diagram showing an example of the input-output characteristics of the photomultiplier tube 30. The horizontal axis represents the electric field amplitude value E of the light (interference light IL) incident on the photomultiplier tube 30. The vertical axis represents the electrical signal (voltage signal V) output by the photomultiplier tube 30. As shown in this figure, the input-output characteristics of the photomultiplier tube 30 are not linear. These input-output characteristics of the photomultiplier tube 30 are obtained in advance. For example, by performing fitting processing using multiple (five in this example) measurement values shown in FIG. 3A, a fitting function R representing the relationship between the electric field amplitude value E and the voltage signal V can be obtained. Such a fitting function R is stored in the analysis unit 50 in advance, for example.

FIG. 3B is a graph showing the time dependence of the voltage signal V output by the photomultiplier tube 30. Such a voltage signal V corresponds to the optical path length difference Δd between the split light L1a (optical path Pa) and the split light L1b (optical path Pb). In other words, the amplitude of the voltage signal V output by the photomultiplier tube 30 (Vp-p) corresponds to the optical path length difference Δd. The Vp-p is used as an indicator of the intensity of the interference light IL. The analysis unit 50, described later, can read the Vp-p from the output result of the photomultiplier tube 30 as shown in FIG. 3B.

The position sensor 40 is disposed behind the mirror member 25 (the side opposite to the parabolic mirror 24). The position sensor 40 detects the reference light L2 transmitted through the mirror member 25 (ITO film 252 and glass substrate 251 in this embodiment). The position sensor 40 is constituted by, for example, a near-infrared CMOS image sensor. The position sensor 40 has a detection surface 40a facing the mirror member 25 (glass substrate 251) and detects the position of the reference light L2 incident on the detection surface 40a. The position sensor 40 is configured to detect the beam position (the position of the reference light L2) displaced on the detection surface 40a according to the rotation of the rotating mirror 23. That is, the position sensor 40 may be constituted by an image sensor having multiple pixels arranged along at least the direction in which the beam position is displaced according to the rotation of the rotating mirror 23. In this embodiment, as shown in FIG. 1, the position sensor 40 may be constituted by a one-dimensional or two-dimensional image sensor capable of detecting the beam position on the X-axis perpendicular to the axis AX of the rotating mirror 23 on a plane parallel to the detection surface 40a. As an example, the beam position is represented by the X coordinate when the beam position at the angle θr of the rotating mirror 23 (when the optical path length difference Δd between the optical path Pa and the optical path Pb is zero) is set as the origin (0) and the direction in which the beam position is displaced when the rotating mirror is rotated in the direction in which the optical path length of the optical path Pb increases is set as the positive direction on the X-axis. The information on the beam position detected by the position sensor 40 is input to the analysis unit 50.

The analysis unit 50 is communicatively connected to the photomultiplier tube 30 and the position sensor 40 and is configured to acquire the detection results of the photomultiplier tube 30 and the position sensor 40. The analysis unit 50 analyzes (identifies) the analyze-target object S based on the detection results of the photomultiplier tube 30 and the position sensor 40. As an example, the analysis unit 50 performs Fourier spectroscopy analysis using the measurement light L1, which is a terahertz wave. In this embodiment, the analysis unit 50 is also configured to control the operation (driving) of the light source 10 (output unit 11), the linear stage 22, and the rotating mirror 23. The analysis unit 50 may be constituted by a computer device including a processor, memory, storage, communication devices, etc. The processes of the analysis unit 50 described in detail below are realized by these hardware elements operating according to a predetermined program.

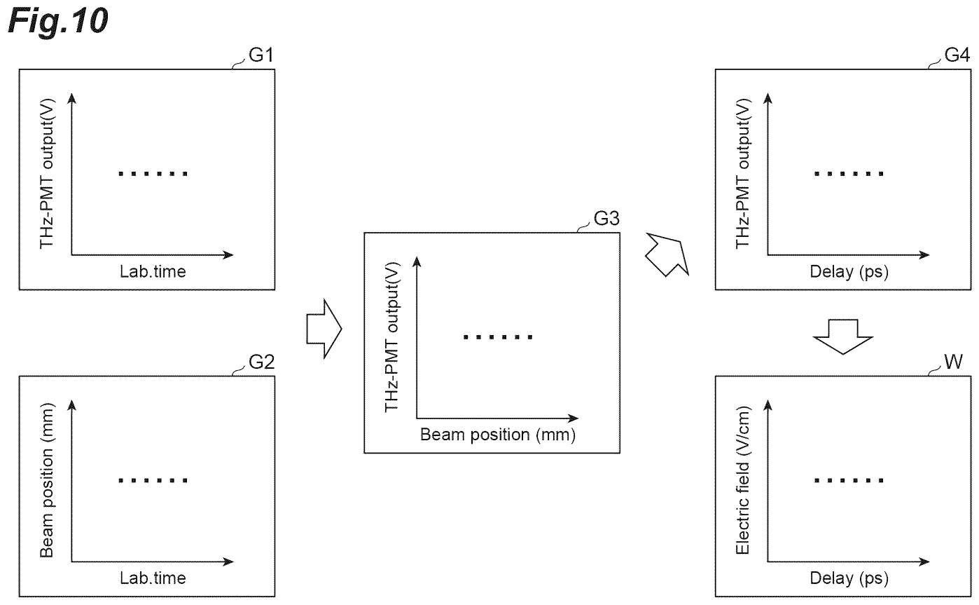

The analysis unit 50 acquires a signal waveform W (see FIG. 10) that associates a measurement value (electric field amplitude value E in this embodiment) corresponding to the intensity of the interference light IL detected by the photomultiplier tube 30 with the optical path length difference (time difference Δt corresponding to the optical path length difference Δd in this embodiment) between the optical path Pa and the optical path Pb, and analyzes the analyze-target object S based on the acquired signal waveform W. The analysis unit 50 monitors the beam position (detection result of the position sensor 40) displaced according to the rotation of the rotating mirror 23 and acquires the signal waveform W based on the beam position.

As an example, the analysis unit 50 executes the following first process to fourth process to perform the above analysis. The details of each process are described below.

### (First Process)

The analysis unit 50 measures the beam position (beam position detected by the position sensor 40 in this embodiment) corresponding to the light incident position on the mirror member 25 for each of a plurality of rotation angles of the rotating mirror 23 and calculates a first relational expression indicating the relationship between the rotation angle of the rotating mirror 23 and the beam position.

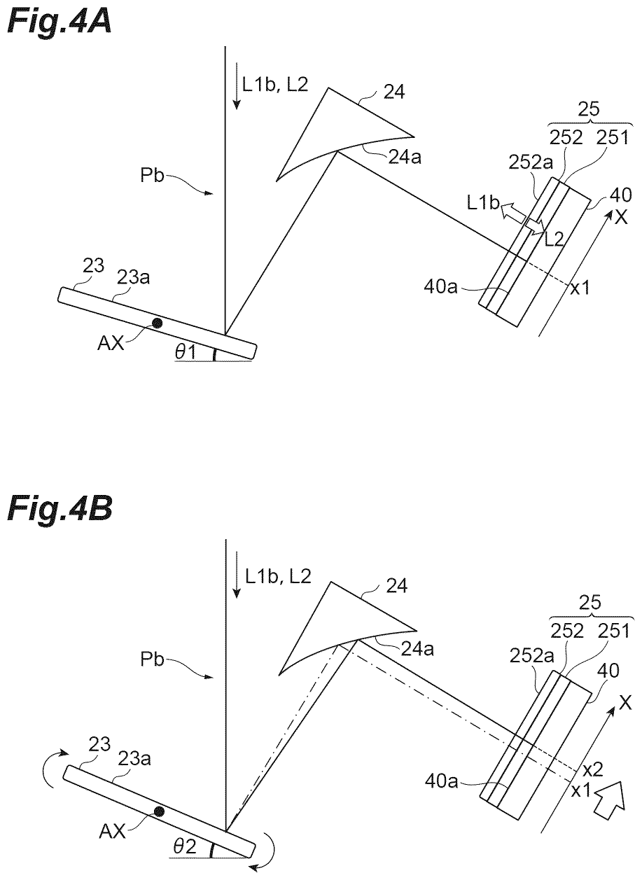

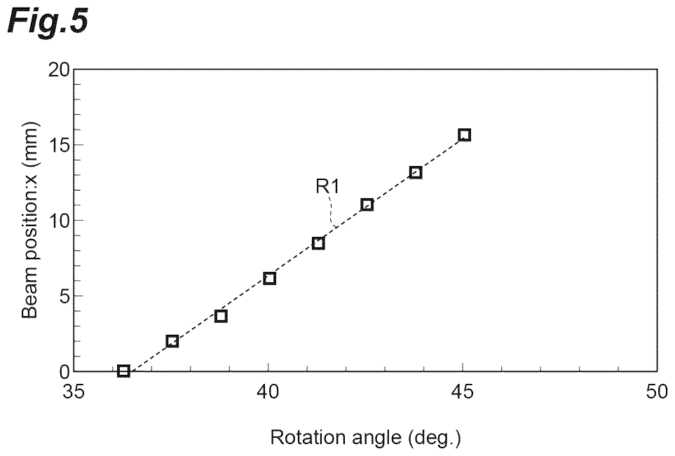

FIG. 4A shows the optical path Pb when the rotation angle of the rotating mirror 23 is set to a certain angle θ1. FIG. 4B shows the optical path Pb after the rotation angle of the rotating mirror 23 is changed to an angle θ2 by rotating the rotating mirror 23 clockwise from the state shown in FIG. 4A. The one-dot chain line in FIG. 4B indicates the optical path Pb corresponding to the angle θ1. As shown, the beam position on the mirror member 25 (i.e., the beam position on the detection surface 40a) is displaced from position x1 to position x2 as the rotation angle of the rotating mirror 23 changes from angle θ1 to angle θ2. Therefore, by measuring the beam positions (x1 and x2 in the example of FIGS. 4A and 4B) corresponding to each of the plurality of rotation angles (θ1 and θ2 in the example of FIGS. 4A and 4B) of the rotating mirror 23, a plot diagram as shown in FIG. 5 can be obtained. FIG. 5 is a graph with the rotation angle of the rotating mirror 23 on the horizontal axis and the beam position detected by the position sensor 40 on the vertical axis, showing the beam position corresponding to each of the plurality (eight in this example) of rotation angles of the rotating mirror 23.

The analysis unit 50 can derive the first relational expression R1 by performing fitting processing on the multiple plot points shown in FIG. 5. The fitting function used in the fitting processing may be a straight line (linear function), a quadratic or higher-order polynomial, an exponential function, a logarithmic function, or other curves. In this embodiment, since there is a linear relationship between the rotation angle of the rotating mirror 23 and the beam position, the analysis unit 50 obtains the first relational expression R1 as the following equation (A). That is, the analysis unit 50 obtains the parameters a and b included in the following equation (A) as information indicating the first relational expression R1 by performing linear fitting on the multiple plot points. In the following equation (A), “x” is a variable indicating the beam position, and “0” is a variable indicating the rotation angle of the rotating mirror 23.

$$x = a θ + b \qquad ( A )$$

### (Second Process)

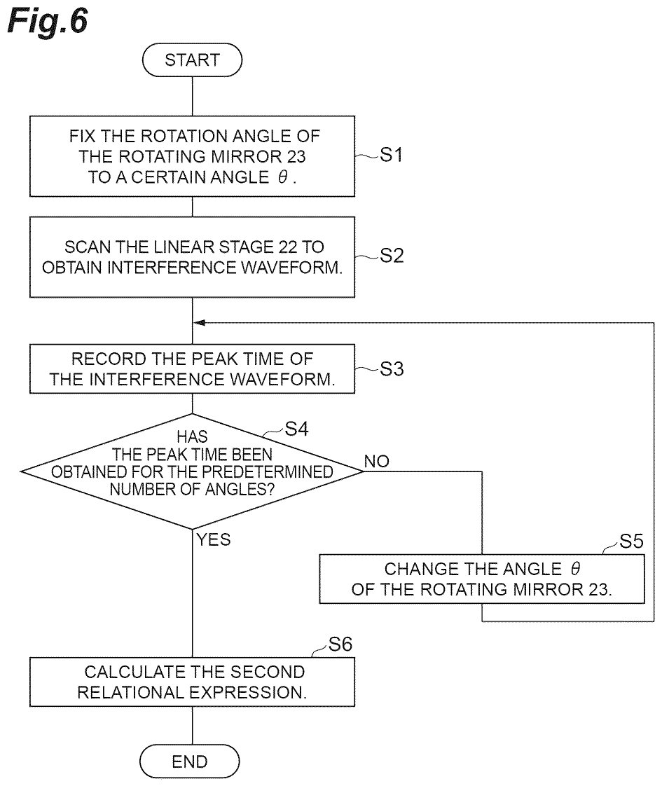

The analysis unit 50 measures the time difference Δt corresponding to the optical path length difference Δd at the time when the peak of the intensity of the interference light IL is obtained for each of the plurality of rotation angles of the rotating mirror 23 and calculates a second relational expression indicating the relationship between the rotation angle of the rotating mirror 23 and the time difference Δt. An example of the second process is described below with reference to the flowchart in FIG. 6.

First, the analysis unit 50 fixes the rotation angle of the rotating mirror 23 to a certain angle θ (step S1). Then, by scanning the linear stage 22 (moving in the direction along the optical path Pa to increase the optical path length of the optical path Pa), the analysis unit 50 acquires one interference waveform representing the detection result of the photomultiplier tube 30 (Vp-p indicating the intensity of the interference light IL) for each delay time Δt (delay time corresponding to the movement distance of the linear stage 22 divided by the speed of light in a vacuum) (step S2).

Here, the movement distance of the linear stage 22 is the distance from the position of the linear stage 22 (origin) where the optical path length difference Δd between the optical path Pa and the optical path Pb is zero when the rotation angle of the rotating mirror 23 is θr. In this way, when the rotation angle of the rotating mirror 23 is set to the angle θr, the peak of the intensity of the interference light IL is obtained when the optical path length difference Δd is zero (i.e., when the movement distance of the linear stage 22 is zero). On the other hand, when the rotation angle of the rotating mirror 23 is set to an angle θ larger than the angle θr and the optical path length of the optical path Pb is increased, the peak of the interference light IL is obtained when the optical path length of the optical path Pa is increased by the same amount as the increase in the optical path length of the optical path Pb. The delay time corresponding to the movement distance of the linear stage 22 at this time corresponds to the time difference Δt for the angle θ of the rotating mirror 23.

Therefore, the analysis unit 50 records the peak time of the interference waveform acquired in step S2 (i.e., the delay time corresponding to the movement distance of the linear stage 22 at the time when the peak of the intensity of the interference light IL is obtained) as the time difference Δt corresponding to the rotation angle (angle θ) of the rotating mirror 23 at that time (step S3).

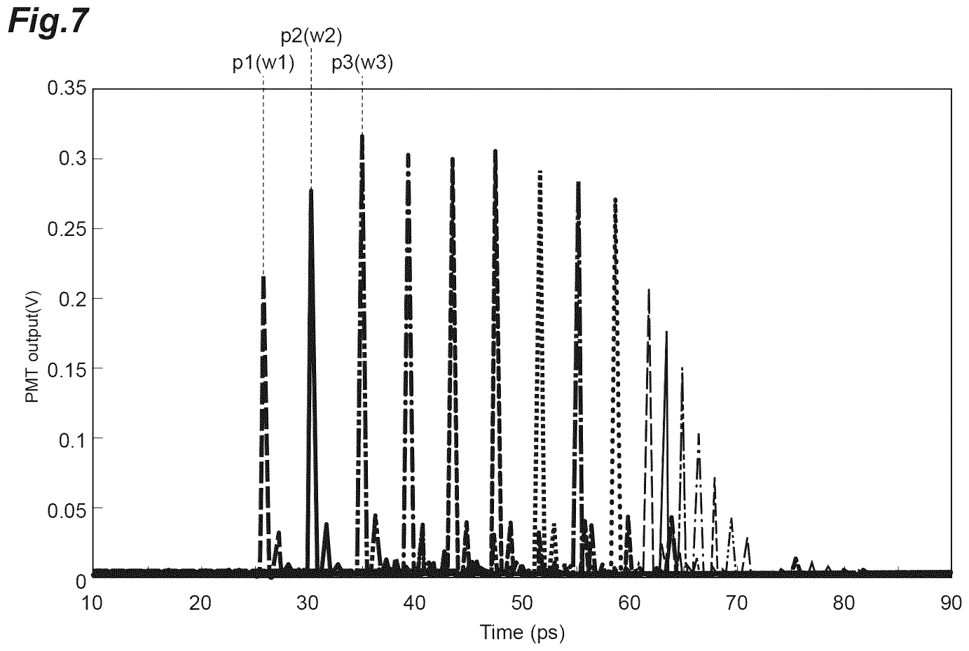

Next, the analysis unit 50 determines whether the peak time has been obtained for a predetermined number of angles θ (step S4). The “predetermined number” is, for example, the number required to calculate the second relational expression R2 with sufficient accuracy by the fitting processing described later, and is a preset number. If the peak time has not been obtained for the predetermined number of angles θ (step S4: NO), the analysis unit 50 changes the angle θ of the rotating mirror 23 (step S5) and executes the processes from step S2 again. By repeating such processes, multiple interference waveforms (w1, w2, w3, etc.) corresponding to multiple angles θ and their respective peak times (p1, p2, p3, etc.) can be obtained as shown in FIG. 7. In the graph shown in FIG. 7, the horizontal axis represents the delay time (time difference Δt) corresponding to the movement distance of the linear stage 22, and the vertical axis represents the intensity (Vp-p) of the interference light IL detected by the photomultiplier tube 30. If the peak time has been obtained for the predetermined number of angles θ (step S4: YES), the analysis unit 50 ends the above processes (repeated processes of steps S2 to S5).

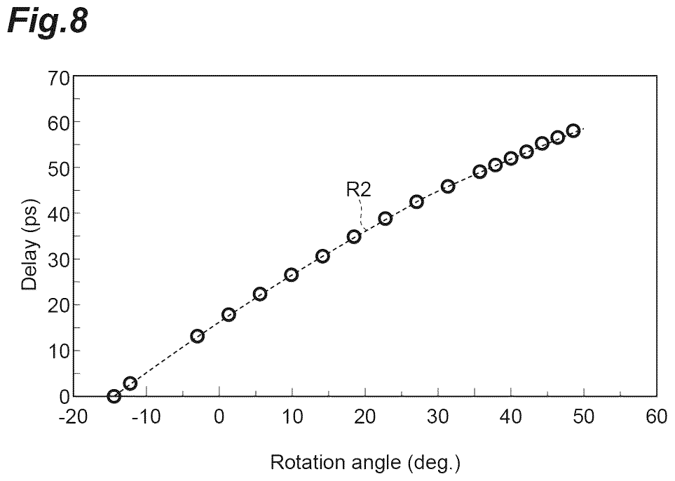

As a result of the above processes, a plot diagram as shown in FIG. 8 is obtained. FIG. 8 is a graph with the rotation angle of the rotating mirror 23 on the horizontal axis and the time difference (delay time) on the vertical axis, showing the time difference corresponding to each of the plurality (eighteen in this example) of rotation angles of the rotating mirror 23.

The analysis unit 50 can derive the second relational expression R2 by performing fitting processing on the multiple plot points shown in FIG. 8. The fitting function used in the fitting processing may be a straight line (linear function), a quadratic or higher-order polynomial, an exponential function, a logarithmic function, or other curves. In this embodiment, the analysis unit 50 obtains the fitting function represented by the following equation (B). That is, the analysis unit 50 obtains the parameters h and θ₀ included in the following equation (B) as information indicating the second relational expression R2 by fitting the multiple plot points with the following equation (B). In the following equation (B), “θ” is a variable indicating the angle of the rotating mirror 23, “Δt(θ)” is a variable indicating the time difference corresponding to the angle θ, and “c” is the speed of light in a vacuum. Note that “θ₀” corresponds to the initial rotation angle (θr) when the optical path length difference Δd is zero, but it may be slightly different from θr due to the fitting process using multiple plot points.

$$Δ t ( θ ) = 2 h / c [ tan θ - tan {θ}_{0} ] \qquad ( B )$$

### (Third Process)

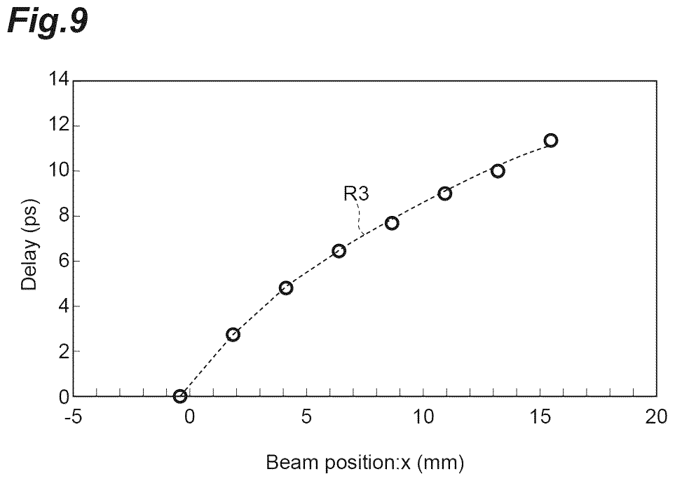

The analysis unit 50 calculates a third relational expression R3 indicating the relationship between the beam position (x) and the time difference (Δt) based on the first relational expression R1 (see FIG. 5) and the second relational expression R2 (see in FIG. 8). Here, based on the graph obtained in the first process (FIG. 5) and the graph obtained in the second process (FIG. 8), the beam position and the time difference corresponding to the same rotation angle are associated with each other, and a graph as shown in FIG. 9 is obtained. FIG. 9 is a graph with the beam position on the horizontal axis and the time difference (delay time) on the vertical axis, showing the pairs of beam positions and time differences corresponding to the same rotation angle. The third process of the analysis unit 50 corresponds to the process of obtaining the fitting function corresponding to the multiple plot points in the graph of FIG. 9.

The analysis unit 50 can obtain the following equation (C) by converting the equation (B) into a function of the beam position “x” based on the equation (A). The following equation (C) corresponds to the fitting function (third relational expression R3) in the graph shown in FIG. 9.

$$Δ t ( x ) = 2 h / c [ tan \{ ( x - b ) / a \} - tan {θ}_{0} ] \qquad ( C )$$

### (Fourth Process)

The analysis unit 50 acquires the signal waveform W for analyzing the analyze-target object S based on the measurement value (electric field amplitude value E in this embodiment) corresponding to the intensity of the interference light IL detected by the photomultiplier tube 30, the beam position x detected by the position sensor 40, and the third relational expression R3 (equation (C) shown above).

An example of the fourth process of the analysis unit 50 is described below with reference to FIG. 10. First, the interferometric optical system 20 is set to the initial state where the optical path length difference Δd is zero (the rotation angle of the rotating mirror 23 is set to the angle θr). The analysis unit 50 starts the driving of the light source 10 (output unit 11) and the rotational driving of the rotating mirror 23 (the operation in which the rotation angle periodically changes between “θr” and “θr+θmax”). As a result, the analysis unit 50 can obtain the graphs G1 and G2 shown in FIG. 10.

The horizontal axis of the graphs G1 and G2 represents the measurement time, which is the elapsed time from the start of the measurement (the start time of the driving of the light source 10 and the rotating mirror 23 described above). The vertical axis of the graph G1 represents the intensity (Vp-p) of the interference light IL. That is, the graph G1 is time-series data of the intensity (Vp-p) of the interference light IL. The analysis unit 50 can obtain the graph G1 based on the voltage signal V at each time point detected by the photomultiplier tube 30. The vertical axis of the graph G2 represents the beam position. That is, the graph G2 is time-series data of the beam position. The analysis unit 50 can obtain the graph G2 based on the beam position at each time point detected by the position sensor 40.

The analysis unit 50 can obtain the graph G3 based on the graphs G1 and G2. More specifically, the analysis unit 50 can obtain the graph G3 with the beam position on the horizontal axis and the intensity (Vp-p) on the vertical axis by associating the beam position and the intensity (Vp-p) of the interference light IL at the same time point.

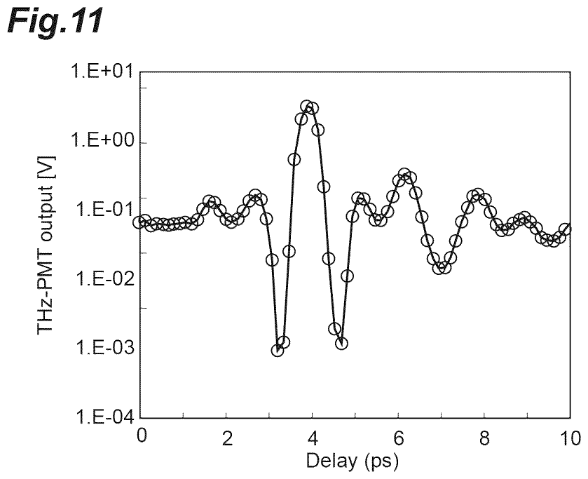

The analysis unit 50 can obtain the graph G4 (i.e., a graph showing the dependence of Vp-p on the time difference Δt) with the time difference Δt on the horizontal axis and the intensity (Vp-p) on the vertical axis by converting the horizontal axis of the graph G3 from the beam position x to the time difference Δt using the third relational expression R3 (equation (C)). FIG. 11 shows an example of the graph G4.

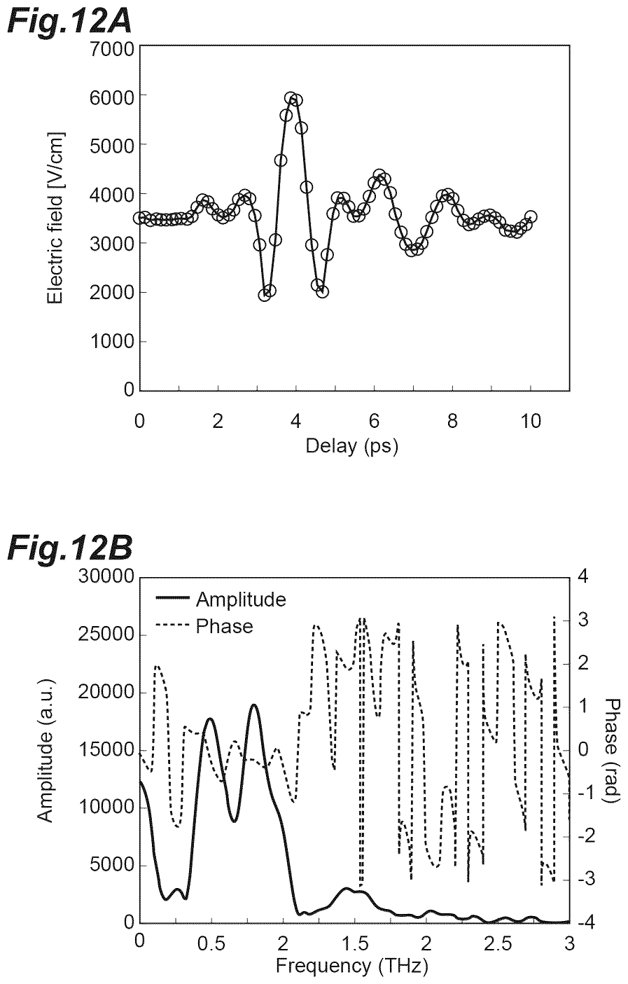

Furthermore, the analysis unit 50 converts the intensity (Vp-p) of the interference light IL into the electric field amplitude value E based on the relationship (fitting function R shown in FIG. 3A) between the electric field amplitude value E of the light incident on the photomultiplier tube 30 and the electrical signal value (voltage signal V) output from the photomultiplier tube 30. As a result, the desired signal waveform W (i.e., a graph showing the dependence of the electric field amplitude value E of the interference light IL on the time difference Δt) can be obtained. FIG. 12A shows an example of the signal waveform W.

Subsequently, the analysis unit 50 analyzes the analyze-target object S by performing Fourier transform based on the dependence of the electric field amplitude value E of the interference light IL on the value of the time difference Δt. The Fourier transform described above provides a graph showing the amplitude spectrum (solid line) and phase spectrum (dashed line) of the electric field amplitude value E of the interference light IL as shown in FIG. 12B.

As described above, in this embodiment, the input-output characteristics of the photomultiplier tube 30 (fitting function R shown in FIG. 3A) are obtained in advance, and the amplitude of the voltage signal V (Vp-p) is converted into the electric field amplitude value E of the interference light IL using this relationship. By using the photomultiplier tube 30 and performing such conversion, Fourier spectroscopy using interferometric measurement with the terahertz wave (measurement light L1) can be performed quickly and accurately.

As described above, the input-output characteristics (FIG. 3A) of the photomultiplier tube 30 are not linear. The output value of the photomultiplier tube 30 may be described by a polynomial with the electric field amplitude value E of the light incident on the photomultiplier tube 30 as a variable, or it may be described using the following equation (1) representing the efficiency of electron emission in the metasurface (Non-Patent Document 4: Simon Lehnskov Lange, et al, “Ultrafast THz-driven electron emission from metal metasurfaces,” J. Appl. Phys. 128, 070901 (2020)). This equation represents the relationship between the current J_{FN} emitted from the metasurface and the electric field amplitude value E of the incident terahertz wave and is called the Fowler-Nordheim relations (hereinafter referred to as “FN equation”).

$${J}_{FN} ( E ) = \frac{{a}_{FN}}{{t}_{F}^{2}} \frac{{( β E )}^{2}}{Φ} exp ( - \frac{{v}_{F} {b}_{FN} {Φ}^{3 / 2}}{β E} ) \qquad ( 1 )$$

In the FN equation, a_{FN} and b_{FN} are called FN constants and have certain values. β is the field enhancement factor, which is about 400 in Non-Patent Document 4. Φ is the work function of the material of the metasurface of the electron emission part 31, which is 3.5 eV for gold. t_{F} and v_{F} are constants. When the electric field amplitude of the incident terahertz wave is not large, the values of t_{F} and v_{F} may be set to 1. In this case, the FN equation is expressed by the following equation (2).

$${J}_{FN} ( E ) = {a}_{FN} \frac{{( β E )}^{2}}{Φ} exp ( - \frac{{b}_{FN} {Φ}^{3 / 2}}{β E} ) \qquad ( 2 )$$

The FN equation represents the relationship between the current J_{FN} emitted from the electron emission part 31 of the photomultiplier tube 30 and the electric field amplitude value E of the incident terahertz wave, but it can also represent the relationship between the output value of the photomultiplier tube 30 and the electric field amplitude value E of the incident terahertz wave.

It is necessary to obtain the values of a_{FN} and b_{FN} in the FN equation. To do this, the electric field amplitude value E of the incident terahertz wave is set to each value, and the output value V of the photomultiplier tube 30 is measured. By performing fitting processing using these measurement values, the values of a_{FN} and b_{FN} can be obtained.

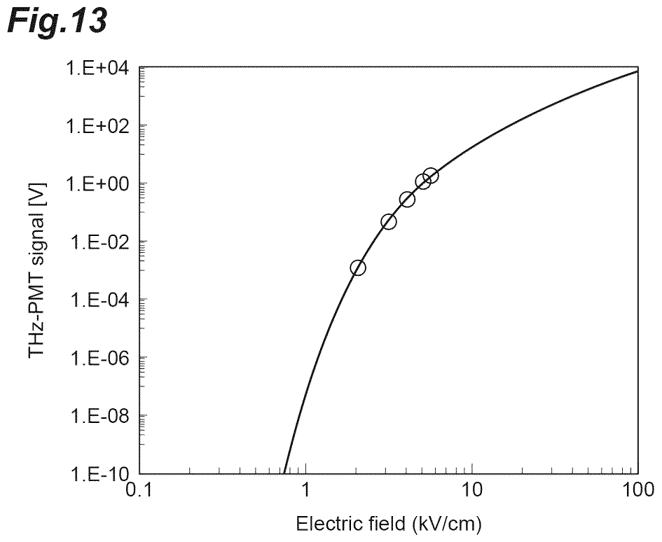

FIG. 13 is a graph showing the relationship (FN equation) between the output value V of the photomultiplier tube 30 and the electric field amplitude value E of the incident terahertz wave obtained by fitting processing. In this figure, five measurement values are indicated by circles.

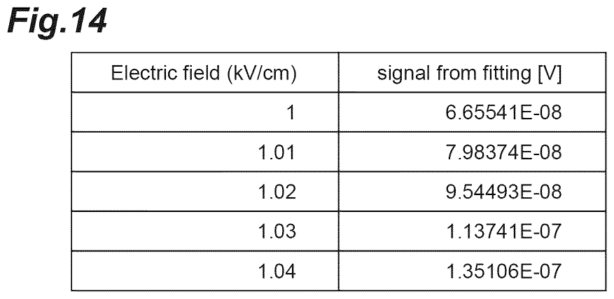

To obtain the electric field amplitude value E of the incident terahertz wave from the output value V of the photomultiplier tube 30 using the FN equation, the following method can be used. The output value V of the photomultiplier tube 30 is calculated for each value of the electric field amplitude value E of the incident terahertz wave using the FN equation. FIG. 14 is a table showing an example of the correspondence between the electric field amplitude value E of the incident terahertz wave and the output value V of the photomultiplier tube 30 calculated using the FN equation. The analysis unit 50 obtains the electric field amplitude value E of the incident terahertz wave that is closest to the actual output value V of the photomultiplier tube 30. Alternatively, the electric field amplitude value E of the incident terahertz wave may be obtained by interpolation calculation.

The analysis unit 50 analyzes the analyze-target object S by performing Fourier transform based on the dependence of the electric field amplitude value E of the interference light IL on the value of the time difference Δt. Specifically, the process is as follows.

In the interferometric measurement apparatus 1 having the interferometric optical system 20 with a Michelson interferometer configuration, the measurement light L1 passes through the analyze-target object S twice. Let the phase refractive index of the analyze-target object S be n(ω), the extinction coefficient be k(ω), and the complex refractive index be n′(ω)=n(ω)+ik(ω), where ω is the angular frequency of the terahertz wave. If the frequency of the terahertz wave (measurement light L1) is f, then ω=2πf, where π is the circular constant and i is the imaginary unit.

Let Eₛₐₘₚₗₑ(ω) be the electric field amplitude value of the interference light IL obtained with the analyze-target object S disposed, and E_{ref}(ω) be the electric field amplitude value of the interference light IL obtained without the analyze-target object S. The ratio T(ω) of these values is expressed by the following equation (3). The interface amplitude transmittance from air to the analyze-target object S is tₐₛ, which is expressed by the following equation (4). The interface amplitude transmittance from the analyze-target object S to air is tₛₐ, which is expressed by the following equation (5). The thickness of the analyze-target object S is d, and c is the speed of light in a vacuum.

$$\begin{matrix}T ( ω ) = \frac{{E}_{sample} ( ω )}{{E}_{ref} ( ω )} = {( {t}_{as} {t}_{s a} )}^{2} exp [ 2 i \frac{\{ {n}^{′} ( ω ) - 1 \} ω d}{c} ] \\ = {( {t}_{as} {t}_{sa} )}^{2} exp [ - \frac{2 k ω d}{c} ] exp [ 2 i \frac{\{ n ( ω ) - 1 \} ω d}{c} ]\end{matrix} \qquad ( 3 )$$

$${t}_{as} = \frac{2}{n ( ω ) + 1} \qquad ( 4 )$$

$${t}_{sa} = \frac{2 n ( ω )}{n ( ω ) + 1} \qquad ( 5 )$$

By decomposing the above equation (3) into real and imaginary parts, the following equations (6) to (8) are obtained. φ(ω) is the phase spectrum, and α(ω) is the absorption coefficient. In the interferometric measurement apparatus 1, the analysis unit 50 can analyze the analyze-target object S based on these equations.

$$n ( ω ) = 1 + \frac{c}{2 ω d} ϕ ( ω ) \qquad ( 6 )$$

$$k ( ω ) = \frac{c}{2 ω d} [ ln {\{ \frac{4 n ( ω )}{n ( ω ) + 1} \}}^{2} - ln \{ T ( ω ) \} ] \qquad ( 7 )$$

$$α ( ω ) = \frac{2 ω k ( ω )}{c} \qquad ( 8 )$$

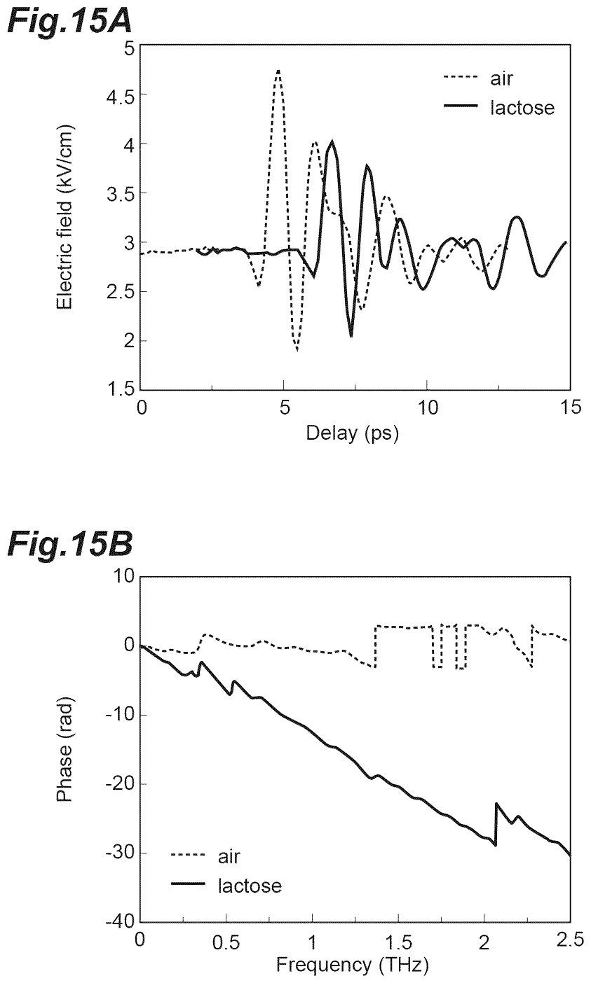

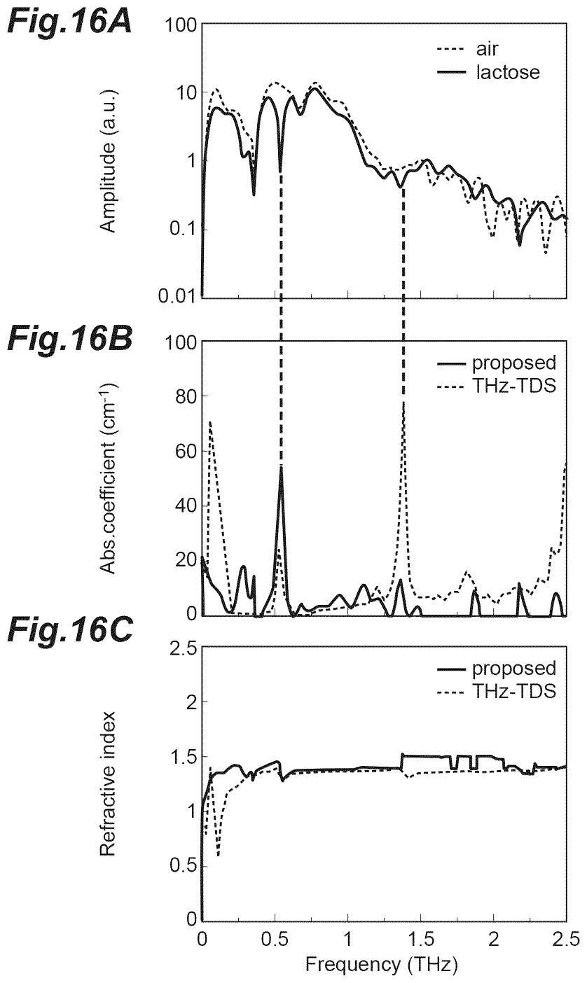

FIGS. 15A, 15B, 16A, 16B and 16C are graphs showing examples of the measurement and analysis results by the interferometric measurement apparatus 1. The graph in FIG. 15A is obtained by the process (conversion to electric field amplitude value E) of the analysis unit 50 described above (corresponding to the graph in FIG. 12A). The graphs in FIGS. 15B and 16A to 16C are obtained by the process (Fourier transform) of the analysis unit 50 described above (corresponding to the graph in FIG. 12B and the graphs derived from it).

FIG. 15A is a graph showing the dependence of the electric field amplitude value E of the interference light IL on the time difference Δt. FIG. 15B is a graph showing the phase spectrum of the electric field amplitude value E of the interference light IL. FIG. 16A is a graph showing the amplitude spectrum of the electric field amplitude value E of the interference light IL. These figures show the cases where the analyze-target object S is disposed and not disposed. In this example, lactose is used as the analyze-target object S.

FIG. 16B is a graph showing the spectrum of the absorption coefficient α(ω). FIG. 16C is a graph showing the spectrum of the refractive index n(ω). These figures show the analysis results according to this embodiment and the analysis results by the THz-TDS of Related Art 1.

As can be seen by comparing the analysis results according to this embodiment with the analysis results by the THz-TDS of Related Art 1, the positions of the absorption peaks appearing in the spectrum of the absorption coefficient α(ω) are consistent between the two. This indicates that the analyze-target object S can be analyzed according to this embodiment.

### [Effects]

According to the interferometric measurement apparatus 1 described above, by rotationally driving the rotating mirror 23, the optical path length difference Δd (i.e., the time difference Δt corresponding to the optical path length difference Δd) between the optical path Pa and the optical path Pb can be changed quickly compared to configuring the rotating mirror 23 as a mirror that can be moved parallel to the mirror surface 23a. Here, to appropriately perform the interferometric measurement, it is necessary to accurately grasp the optical path length difference (time difference Δt) at each measurement point, which requires obtaining information on the rotation angle of the rotating mirror 23 at each point. However, when the rotating mirror 23 is rotationally driven at high speed, it is difficult to directly grasp the rotation angle of the rotating mirror 23 at each point. Therefore, in the interferometric measurement apparatus 1, instead of monitoring the rotation angle of the rotating mirror 23 itself, the beam position on the mirror member 25 displaced according to the rotation of the rotating mirror 23 is monitored to indirectly grasp the rotation angle of the rotating mirror 23, and obtain a signal waveform W (a graph showing the dependence of the electric field amplitude value E on the time difference Δt as shown in FIG. 12A) that associates the measurement value (corresponding to the intensity of the interference light IL) of the photomultiplier tube 30 with the optical path length difference (time difference Δt) corresponding to the rotation angle. This allows the analysis (Fourier spectroscopy analysis in this embodiment) based on the signal waveform W to be performed quickly and easily by quickly changing the optical path length difference (time difference Δt) between the optical path Pa and the optical path Pb by rotationally driving the rotating mirror 23. Therefore, according to the interferometric measurement apparatus 1, interferometric measurement using the measurement light L1 can be performed quickly and suitably.

The light source 10 is configured to further output reference light L2 having a wavelength different from that of the measurement light L1 and incident coaxially with the measurement light L1 into the beam splitter 21. The analysis unit 50 monitors the beam position (the light incident position of the reference light L2 on the mirror member 25 transmitted through the mirror member 25 and reaching the detection surface 40a in this embodiment) corresponding to the light incident position of the reference light L2 on the mirror member 25 displaced according to the rotational driving of the rotating mirror 23. According to the above configuration, by using reference light L2 different from the measurement light L1 for monitoring the beam position, it is possible to prevent a part of the measurement light L1 from being used for monitoring the beam position. This prevents a reduction in the amount of interference light IL of the measurement light L1 detected by the photomultiplier tube 30, allowing interferometric measurement using the measurement light L1 to be performed more suitably.

The interferometric measurement apparatus 1 includes the position sensor 40 that detects the reference light L2 transmitted through the mirror member 25. The mirror member 25 (ITO film 252) reflects the measurement light L1 and transmits the reference light L2. The analysis unit 50 monitors the light incident position of the reference light L2 on the detection surface 40a of the position sensor 40 as the beam position. According to the above configuration, only the measurement light L1 (split light L1b) is reflected by the mirror member 25, and the reference light L2 used for monitoring the beam position does not return to the beam splitter 21 side. This prevents the reference light L2 from returning to the light source 10 side and unexpectedly affecting the interferometric measurement, thereby improving the stability of the interferometric measurement.

The mirror member 25 and the detection surface 40a of the position sensor 40 are arranged so that an air layer is not formed between them. In this embodiment, the position sensor 40 is arranged so that the detection surface 40a is in contact with the back surface (the surface opposite to the ITO film 252) of the glass substrate 251. According to the above configuration, since the detection surface 40a of the position sensor 40 is disposed close to the back surface of the mirror member 25 (the surface opposite to the mirror surface 252a of the ITO film 252), the displacement of the beam position of the reference light L2 according to the rotation of the rotating mirror 23 can be accurately detected by the position sensor 40. As a result, the accuracy of the interferometric measurement can be improved.

The mirror member 25 includes the ITO film 252. According to the above configuration, a mirror member 25 that reflects the measurement light L1 included in a wavelength range of the mid-infrared region or terahertz region and transmits the reference light L2 not included in the above wavelength range can be suitably realized.

The light source 10 includes an output unit 11 that outputs pulsed light (reference light L2) and an optical crystal 12 that generates the measurement light L1 in response to irradiation of the pulsed light, and outputs the pulsed light transmitted through the optical crystal 12 as the reference light L2. According to the above configuration, since only the device that generates the pulsed light (reference light L2) as the seed light needs to be prepared as the light source device (output unit 11), the overall configuration of the light source 10 can be made compact. Furthermore, by using pulsed light with a relatively high wavelength conversion efficiency in the optical crystal 12, the measurement light L1 can be generated efficiently.

In this embodiment, the reference light L2 is near-infrared light (light with a wavelength of 800 nm as an example). There are many optical crystals (such as the ZnTe crystal described above) that generate terahertz waves in response to irradiation with near-infrared light. Therefore, according to the above configuration, the measurement light L1, which is a terahertz wave, can be generated efficiently, and the degree of freedom in selecting the material of the optical crystal 12 can be improved.

The analysis unit 50 analyzes the analyze-target object S by executing the first process to the fourth process described above. According to the above configuration, by performing simple calculation processes step by step, the signal waveform W for analyzing the analyze-target object S can be obtained reliably and easily.

The interferometric optical system 20 is configured to be capable of changing the optical path length of the optical path Pa by driving the linear stage 22. As described above with reference to FIGS. 6 to 8, in the second process, the analysis unit 50 measures the time difference Δt corresponding to each of the plurality of rotation angles of the rotating mirror 23 by driving the linear stage 22 while fixing the rotation angle of the rotating mirror 23 to a certain angle θ. According to the above configuration, by driving the linear stage 22 forming the optical path Pa, the process of measuring the time difference corresponding to each of the plurality of rotation angles in the second process can be performed efficiently.

The analysis unit 50 converts the intensity (Vp-p) of the interference light IL detected by the photomultiplier tube 30 into the electric field amplitude value E based on the relationship (FN equation (fitting function R) obtained by fitting processing in this embodiment) between the electric field amplitude value E of the light incident on the photomultiplier tube 30 and the electrical signal value output from the photomultiplier tube 30, and acquires the signal waveform W that associates the electric field amplitude value E with the time difference Δt corresponding to the optical path length difference, and analyzes the analyze-target object S by performing Fourier transform on the signal waveform W. According to the above configuration, Fourier spectroscopy using interferometric measurement with the measurement light L1 can be performed quickly and accurately.

### [Modifications]

The present disclosure has been described with reference to several embodiments, but the present disclosure is not limited to the configurations shown in the above embodiments. The materials and shapes of the respective components are not limited to the specific materials and shapes described above, and various other materials and shapes can be adopted. Furthermore, some of the configurations included in the above embodiments may be omitted or changed as appropriate, and may be combined arbitrarily.

For example, the photomultiplier tube 30 may be capable of imaging the intensity distribution of the incident light. When the electron multiplication part 32 includes a microchannel plate (e.g., image intensifier), the intensity distribution of the incident light can be imaged. By using such a photomultiplier tube 30, it is possible to perform imaging analysis of the analyze-target object S.

In the above embodiment, the analysis unit 50 analyzes (identifies) the analyze-target object S by converting the intensity (Vp-p) of the interference light IL into the electric field amplitude value and performing Fourier transform based on the dependence of the electric field amplitude value on the time difference Δt. However, the analysis unit 50 may analyze the analyze-target object S by other methods. For example, the analysis unit 50 may analyze the analyze-target object S by other methods without converting the intensity (Vp-p) of the interference light IL (see FIG. 11) corresponding to each value of the time difference Δt into the electric field amplitude value. For example, the graph G4 (shown in FIG. 10) before converting Vp-p into the electric field amplitude value E may be used as the signal waveform for analyzing the analyze-target object S. Even in such cases, the same effects as those of the interferometric measurement apparatus 1 described above can be achieved. That is, by indirectly grasping the rotation angle of the rotating mirror 23 based on the monitoring result of the beam position, and obtaining the signal waveform (graph G4 in FIG. 10) that associates the detection result of the photomultiplier tube 30 with the optical path length difference (time difference Δt) corresponding to the rotation angle, the analysis based on the signal waveform can be performed quickly and easily by quickly changing the optical path length difference Δd by rotationally driving the rotating mirror 23.

The components constituting the interferometric optical system 20 may be changed or omitted as appropriate within the range that allows the measurement by the interferometric measurement apparatus 1 described above. Similarly, the arrangement of the components constituting the interferometric optical system 20 may be changed as appropriate. Furthermore, other optical components not described in the above embodiments may be added to the interferometric optical system 20 as appropriate.

The analyze-target object S may be disposed on the optical path through which the measurement light L1 passes. For example, the analyze-target object S may be disposed on the optical path Pb (e.g., between the beam splitter 21 and the rotating mirror 23). However, in this embodiment, since the optical path Pb changes during measurement due to the driving of the rotating mirror 23, the conditions of the measurement light L1 (split light L1b) passing through the analyze-target object S are not constant. This may cause unexpected measurement errors. From this perspective, it is preferable to dispose the analyze-target object S on the optical path Pa, which does not change its optical path length during measurement. Alternatively, the analyze-target object S may be disposed on the optical path through which the measurement light L1 passes outside the optical paths Pa and Pb (e.g., between the optical crystal 12 and the beam splitter 21, or between the beam splitter 21 and the photomultiplier tube 30). Disposing the analyze-target object S outside the optical paths Pa and Pb can suppress the reduction of the interference signal (interference light IL) due to the influence of the wavefront distortion of the analyze-target object S. On the other hand, when the analyze-target object S is disposed outside the optical paths Pa and Pb, information on the absorption spectrum of the analyze-target object S can be obtained, but information on the refractive index of the analyze-target object S cannot be obtained. In other words, by disposing the analyze-target object S on the optical path Pa or the optical path Pb, information on both the absorption spectrum and the refractive index of the analyze-target object S can be obtained.

The measurement light L1 may be mid-infrared light (light included in the wavelength range of the mid-infrared region). In this case, the photomultiplier tube 30 may be replaced with a detector sensitive to the mid-infrared region. Even with such a configuration, the same effects as those of the above embodiment can be obtained.

The reference light L2 may be visible light (light included in the wavelength range of 380 nm to 780 nm). In this case, by visually recognizing the position of the reference light L2, it is possible to easily perform assembly work of the interferometric optical system 20 (e.g., arrangement of the parabolic mirror 24 and the mirror member 25) and monitoring of the beam position on the mirror member 25. Furthermore, the position sensor 40 for detecting the reference light L2 can be constituted by a relatively inexpensive light detector.

In the above embodiment, since ITO-coated glass is used as the mirror member 25, the glass substrate 251 exists between the ITO film 252 functioning as a mirror reflecting the measurement light L1 (split light L1b) and the detection surface 40a of the position sensor 40. Here, when the measurement light L1 and the reference light L2 are focused on the mirror surface (surface 252a of the ITO film 252) of the mirror member 25, it is preferable to bring the detection surface 40a of the position sensor 40 as close as possible to the mirror surface to improve the measurement accuracy of the beam position. Therefore, the ITO film 252 may be formed directly on the detection surface 40a of the position sensor 40. This allows the detection surface 40a to be brought closer to the mirror surface by the thickness of the glass substrate 251 in the above embodiment, thereby improving the measurement accuracy of the beam position.

In the above embodiment, the parabolic mirror 24 is used as the optical component disposed between the rotating mirror 23 and the mirror member 25, but other optical components such as lenses that condense or collimate the split light L1b from the rotating mirror 23 may be used. Examples of such lenses include lenses formed of plastic materials such as Tsurupica (registered trademark) and ZEONEX (registered trademark), or silicon. However, from the perspective of eliminating phase shift, it is preferable to use reflective optical components such as the parabolic mirror 24 rather than transmissive optical components such as lenses. Furthermore, the rotating mirror 23 itself may have the function of condensing or collimating the split light L1b, but even in such cases, it is preferable to dispose an optical component (the parabolic mirror 24 in the above embodiment) between the rotating mirror 23 and the mirror member 25 to return the split light L1b reflected by the mirror member 25 to the same position on the rotating mirror 23.

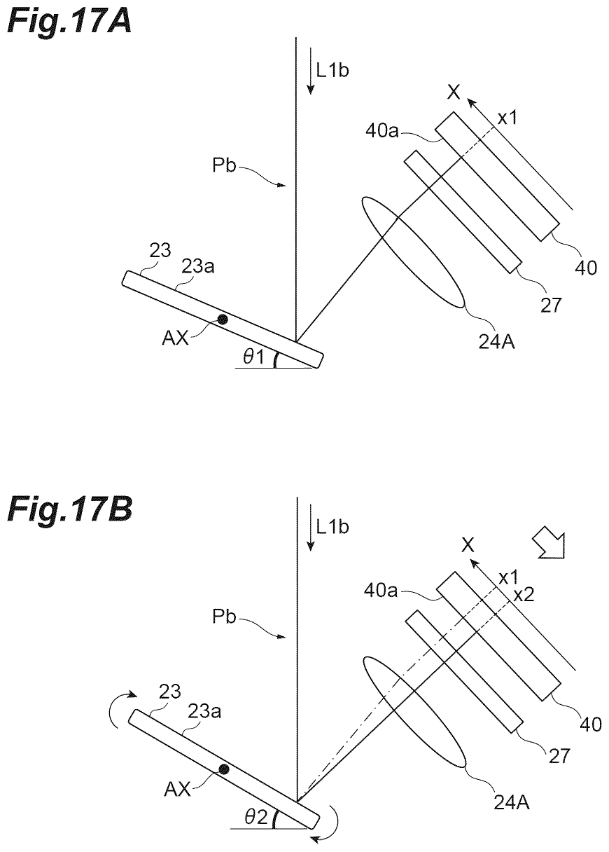

In the above embodiment, the measurement light L1 is generated by irradiating the optical crystal 12 with the reference light L2, but separate light source devices (laser light sources, etc.) for outputting the measurement light L1 and the reference light L2 may be prepared. Furthermore, if the reference light L2 is not used for monitoring the beam position, the reference light L2 is not essential. That is, the light source 10 may be configured to output only the measurement light L1 to the beam splitter 21. In this case, the interferometric measurement apparatus 1 may adopt a configuration as shown in FIGS. 17A and 17B.

FIG. 17A shows the optical path Pb when the rotation angle of the rotating mirror 23 is set to a certain angle θ1. FIG. 17B shows the optical path Pb after the rotation angle of the rotating mirror 23 is changed to an angle θ2 by rotating the rotating mirror 23 clockwise from the state shown in FIG. 17A. The one-dot chain line in FIG. 17B indicates the optical path Pb corresponding to the angle θ1. As shown in FIGS. 17A and 17B, a beam splitter 27 (third mirror) may be used instead of the mirror member 25. In the example of FIGS. 17A and 17B, a lens 24A as described above is used instead of the parabolic mirror 24. The position sensor 40 is disposed behind the beam splitter 27 (the side opposite to the rotating mirror 23) at a position separated from the beam splitter 27. The beam splitter 27 transmits a part of the measurement light L1 (split light L1b) and reflects the remaining component of the measurement light L1. The measurement light L1 transmitted through the beam splitter 27 enters the detection surface 40a of the position sensor 40. Even with such a configuration, the beam position corresponding to the light incident position of the measurement light L1 on the beam splitter 27 can be detected by the position sensor 40. However, in the above configuration, since a part of the measurement light L1 is used for monitoring the beam position, the amount of interference light IL of the measurement light L1 detected by the photomultiplier tube 30 is reduced accordingly. From the perspective of preventing the reduction of the amount of interference light IL, it is preferable to use reference light L2 different from the measurement light L1 for monitoring the beam position as in the above embodiment.

Furthermore, the third mirror provided at the folding position in the optical path Pb may be a member that does not transmit either the measurement light L1 or the reference light L2, such as a metal mirror. In this case, for example, the beam position may be detected by imaging the light incident position (focal point) of the reference light L2 on the third mirror, which is visible light, as described above. However, by detecting the light transmitted through the third mirror as in the above embodiment, the arrangement of the position sensor 40 and the detection of the beam position can be performed easily.

In the above embodiment, the photomultiplier tube 30 sensitive to the terahertz region is used as the detector (first detector) for detecting the measurement light L1, but detectors other than the photomultiplier tube may be used. However, from the perspective of realizing high-speed interferometric measurement, it is preferable that the first detector is a high-speed detector (e.g., a semiconductor detector element such as a Schottky barrier diode) with a response speed of 10 Hz or more, rather than a thermal detector.

What is claimed is:

1. An interferometric measurement apparatus comprising:
a light source that outputs measurement light included in a wavelength range of mid-infrared region or terahertz region;
an interferometric optical system that includes: a beam splitter that splits the measurement light output from the light source into a first split light and a second split light; a first optical path on which the first split light from the beam splitter is reflected by a first mirror and re-enters the beam splitter; and a second optical path on which the second split light from the beam splitter travels to a third mirror via a second mirror and an optical component in this order and returns to the beam splitter via the optical component and the second mirror after being reflected by the third mirror, and wherein the interferometric optical system is configured to combine the first split light and the second split light re-entered into the beam splitter;
a first detector sensitive to the wavelength of the measurement light and configured to detect interference light of the measurement light generated by the combination of the first split light and the second split light at the beam splitter;
an analysis unit configured to acquire a signal waveform that associates a measurement value corresponding to an intensity of the interference light detected by the first detector with an optical path length difference between the first optical path and the second optical path, and analyze an analyze-target object disposed on an optical path of the measurement light based on the acquired signal waveform,
wherein the second mirror is configured to be rotationally driven to change an optical path length of the second optical path,
wherein the optical component is configured to condense or collimate the second split light from the second mirror, and
wherein the analysis unit is configured to monitor a beam position corresponding to a light incident position on the third mirror displaced according to rotation of the second mirror, and acquire the signal waveform based on the beam position.

2. The interferometric measurement apparatus according to claim 1,
wherein the light source further outputs reference light having a wavelength different from that of the measurement light and incident coaxially with the measurement light into the beam splitter, and
wherein the analysis unit is configured to monitor the beam position corresponding to a light incident position of the reference light on the third mirror displaced according to rotation of the second mirror.

3. The interferometric measurement apparatus according to claim 2,
further comprising a second detector configured to detect the reference light transmitted through the third mirror,
wherein the third mirror is configured to reflect the measurement light and transmit the reference light, and
wherein the analysis unit is configured to monitor a light incident position of the reference light on a detection surface of the second detector as the beam position.

4. The interferometric measurement apparatus according to claim 3,
wherein the third mirror and the detection surface of the second detector are arranged so that an air layer is not formed between the third mirror and the detection surface.

5. The interferometric measurement apparatus according to claim 3,
wherein the third mirror includes an ITO film.

6. The interferometric measurement apparatus according to claim 2,
wherein the light source includes an output unit that outputs pulsed light and an optical crystal that generates the measurement light in response to irradiation of the pulsed light, and
wherein the light source is configured to output the pulsed light transmitted through the optical crystal as the reference light.

7. The interferometric measurement apparatus according to claim 2,
wherein the reference light is visible light.

8. The interferometric measurement apparatus according to claim 6,
wherein the reference light is near-infrared light.

9. The interferometric measurement apparatus according to claim 1,
wherein the analysis unit is configured to:
perform a first process of measuring the beam position for each of a plurality of rotation angles of the second mirror and calculating a first relational expression indicating a relationship between the rotation angle of the second mirror and the beam position;
perform a second process of measuring a time difference corresponding to the optical path length difference at a time when a peak of the intensity of the interference light of the measurement light is obtained for each of the plurality of rotation angles of the second mirror and calculating a second relational expression indicating a relationship between the rotation angle of the second mirror and the time difference;
perform a third process of calculating a third relational expression indicating a relationship between the beam position and the time difference based on the first relational expression and the second relational expression; and
perform a fourth process of acquiring the signal waveform based on the measurement value corresponding to the intensity of the interference light detected by the first detector, the beam position, and the third relational expression.

10. The interferometric measurement apparatus according to claim 9,
wherein the first mirror is configured to be driven to change an optical path length of the first optical path, and
wherein the analysis unit is configured to measure the time difference corresponding to the angle for a plurality of angles by driving the first mirror while fixing the rotation angle of the second mirror to a certain angle in the second process.

11. The interferometric measurement apparatus according to claim 1,
wherein the first detector is a photomultiplier tube, and
wherein the analysis unit is configured to convert the intensity of the interference light detected by the first detector into an electric field amplitude value based on a relationship between the electric field amplitude value of the light incident on the first detector and the electrical signal value output from the first detector, acquire the signal waveform that associates the electric field amplitude value with the time difference corresponding to the optical path length difference, and analyze the analyze-target object by performing Fourier transform on the signal waveform.
